(19) United States
(12) Patent Application Publication
(10) Pub. No.: US 2011/0018965 A1
(43) Pub. Date: Jan. 27, 2011

(54) APPARATUS FOR OPTIMIZING GEOMETRIC CALIBRATION

(75) Inventors: Nikolaus Andrew Schad, Rochester, NY (US); Matthew Vartan Kremens, Rochester, NY (US)

Correspondence Address: Stephen B. Salai, Esq.;Harter Secrest & Emery LLP, 1600 Bausch & Lomb Place, Rochester, NY, 14604-2711, US

(73) Assignee: Geospatial Systems, Inc., West Henrietta, NY (US)

(21) Appl. No.: 12/842,727

(22) Filed: Jul. 23, 2010

Related U.S. Application Data
(60) Provisional application No. 61/227,786, filed on Jul. 23, 2009.

(51) Int. Cl. H04N 17/00; H04N 13/00

(52) U.S. Cl. 348/42; 348/188; 348/E17.002; 348/E13.001

(57) ABSTRACT

An apparatus for enabling geometric lens distortion calibration for a metric digital camera includes a turntable, a cage mounted on the turntable, and an array of targets disposed on the cage. The device provides distribution of image references points in three planes and is rotatable, allowing minimal movement of the camera being calibrated in three dimensions and reducing space requirements for calibration facilities.

This application claims the benefit of U.S. Provisional Patent Application No. 61/227,786, filed Jul. 23, 2009.

### BACKGROUND OF THE INVENTION

1. Technical Field

The invention relates to the calibration of cameras, and, in particular, to defining calibration parameters associated with geometric characteristics of the digital camera system.

2. Description of Related Art

Development of digital cameras in terms of the size of a Charged Coupled Device (CCD) and Complementary Metal Oxide Semiconductor (CMOS) arrays, as well as reduced costs, have enabled their applications in traditional and new photogrammetric, surveying, and mapping functions, plus military and security functions such as intelligence gathering, surveillance and reconnaissance. Such cameras require careful calibration to determine their metric characteristics, as defined by the Interior Orientation Parameters (IOP), which are essential for any photogrammetric activity.

In CCD cameras, either a CCD matrix, CMOS array or one or more CCD lines is/are located in the focal plane behind the optical system. Geometric calibration is the determination of the viewing direction of every individual sensor pixel in the object space. If ideally distortion-free optics are used and the geometric location of every sensor pixel in the focal plane is known, the respective viewing direction can be calculated in a simple manner. However, in the case of real optics, distortions are unavoidable. Further, the sensor pixels have certain tolerances with respect to their position in the focal plane. This is due, on the one hand, to the fact that adjustment in the focal plane cannot be carried out exactly. On the other hand, because of deviations due to the technique for assembling or mounting the CCD matrix or CCD lines, the latter are not completely planar or flat, but have curves and/or bends.

Another requirement for a method for geometric calibration is the determination of the imaging sharpness for the entire system. The knowledge of the interior orientation of a camera used for image acquisition is a prerequisite for precise photogrammetric object reconstruction. Parameters such as principal distance, principal point coordinates with reference to the image coordinate system, and some correction terms for lens distortion, etc., are determined by camera calibration.

Conventionally, photogrammetric camera calibration has usually been carried out together with the calculation of object coordinates within a self-calibrating bundle adjustment. To gather information for calibration, the camera to be calibrated captures images with target objects dispersed with known spatial dimensions within a cage framework. The camera is moved relative to the cage to capture the target objects at different perspectives and distances from the calibration cage. The quality of the result depends on several influences, mainly on the image configuration. If the network geometry (i.e., the distribution of reference points in the calibration images) is not adequate to self calibration requirements, a priori knowledge of the camera parameters is needed for the object reconstruction.

In photogrammetry, a series of commercially available programs exists to solve the calibration task. These calibration software programs require a number of images captured with the camera being calibrated. These images display reference points distributed in space and captured from different camera perspectives. The devices holding these reference points are often referred to as calibration “cages”. These fixtures to date have been constructed as rather large items, for example 12 foot wide by 8 feet high by 8 feet deep, using metal frameworks. The facilities housing these cages need to be at least three times as wide as the cages to accommodate the perspective angles for camera placement during calibration.

Thus, there is a need in the art for a compact, repeatedly movable calibration cage usable in a confined space to calibrate a camera.

### SUMMARY OF THE INVENTION

An improved apparatus is disclosed herein for the geometric calibration of digital cameras.

According to one aspect of the invention, a calibration cage for calibrating a camera includes a base; a rotatable turntable disposed on the base and rotatable relative to the base; a cage disposed on the turntable and thereby for rotation relative to the base between a normal position and at least one predetermined rotated position; and an array of targets disposed at predetermined locations on the cage.

In another aspect of the invention, a system for calibrating a camera includes a camera having a field of view, a rotatable turntable, and a calibration cage mounted on the turntable and spaced from the camera. The calibration cage has a three-dimensional array of targets disposed in the field of view of the camera, and the turntable is actuatable to rotate the calibration cage between a plurality of view angles. Each of the plurality of view angles presents the three-dimensional array of targets differently in the field of view of the camera.

In a further aspect of the invention, a method of calibrating a camera includes providing a camera to be calibrated, the camera having a field of view; providing a calibration cage spaced from the camera, the calibration cage having a three-dimensional array of targets disposed in the field of view of the camera; mounting the calibration cage on a turntable; capturing a first image of the calibration cage using the camera; rotating the calibration cage on the turntable to a rotated position, still in the field of view of the camera; capturing a second image of the calibration cage using the camera; and calibrating the camera based on the first and second captured images.

In another aspect of the invention, the apparatus for calibrating a camera and the method of calibrating the camera require far less facility space.

In yet another aspect, the apparatus is movable to obtain images required for calibration, including perspective images, that heretofore were obtained only by moving the camera, which is less repeatable and prone to human error.

As another advantage, the apparatus is constructed from a non-heat conductive material, thus allowing for further improvements in accuracy, because the positioning of the reference signaling points does not change due to the heat from light sources during calibration image capture.

An understanding of these and other aspects and features of the present invention may be had with reference to the attached figures and following description, in which the present invention is illustrated and described.

### BRIEF DESCRIPTION OF THE DRAWING FIGURES

The novel aspects of the invention are described with particularity in the appended claims. The invention itself, together with the further objects and advantages thereof, may be more readily comprehended by reference to the following detailed description of several preferred embodiments thereof taken in conjunction with the attached drawings, in which:

FIG. 1 is a perspective view of a digital camera calibration system according to a preferred embodiment of the subject invention;

FIG. 2 is a perspective view of a calibration cage used in the digital camera calibration system of FIG. 1;

FIG. 3 is a top plan view of the calibration cage illustrated in FIG. 2;

FIG. 4 is a front elevation view of the calibration cage illustrated in FIG. 2;

FIG. 5 is a side elevation view of an alternative embodiment of a calibration cage used in the digital camera calibration system of FIG. 1;

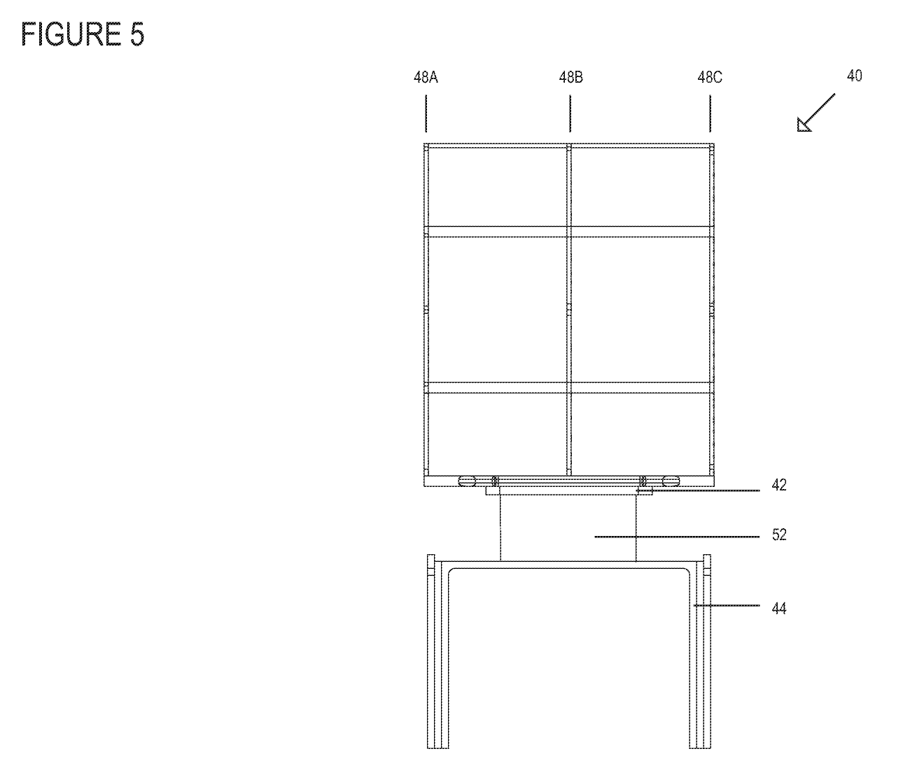

FIG. 6 is a front elevation view of an alternative embodiment of a calibration cage used in the digital camera calibration system of FIG. 1;

FIG. 7 is a table showing results of a camera calibration using a calibration method according to the present invention.

### DETAILED DESCRIPTION OF THE INVENTION

In the following description of the preferred embodiments of the present invention, reference is made to the accompanying drawings which form a part hereof, and in which is shown by way of illustration specific embodiments in which the invention may be practiced. It is understood that other embodiments may be utilized and structural changes may be made without departing from the spirit and scope of the present invention.

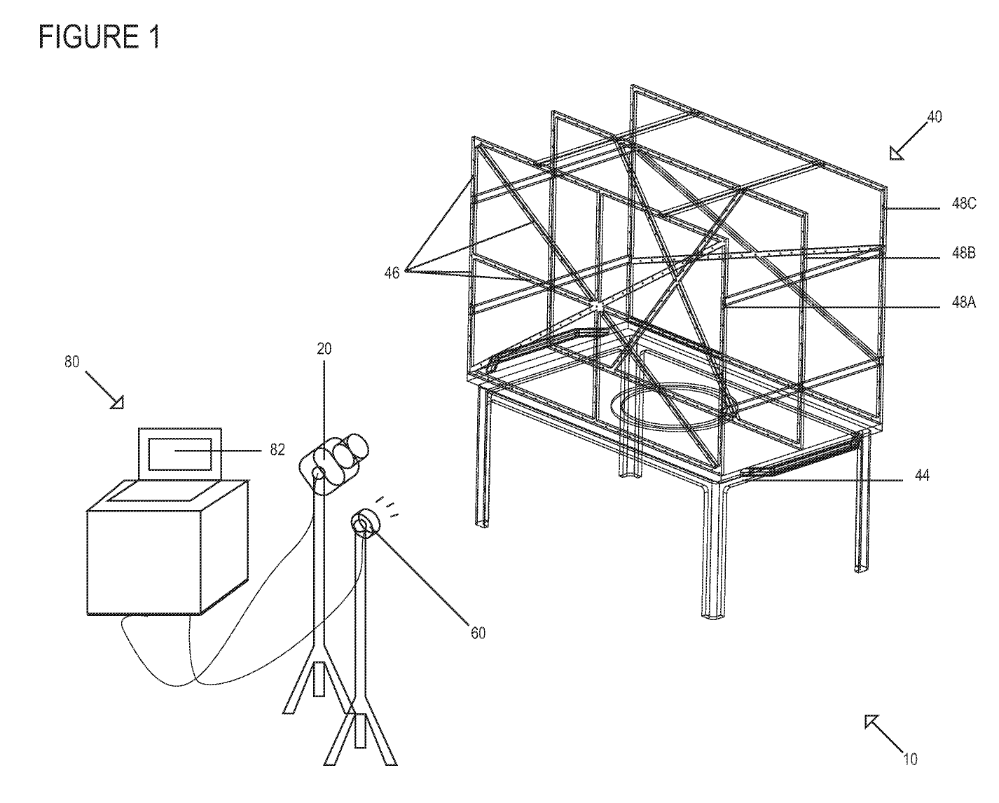

The invention relates to a system and method for calibrating digital cameras. FIG. 1 illustrates one embodiment of the invention. More particularly, FIG. 1 shows a system 10 that generally includes a camera 20 to be calibrated, a calibration cage 40 spaced from the camera 20, a light source 60, and a capture station 80.

As will be described in more detail below, the camera 20 can be any number of cameras, including optical, thermal, or longwave IR. Cameras calibrated with the invention typically range from 2 MegaPixel to 60 MegaPixel, and pixel sizes can go as low as 5 um square and smaller. Focal lengths of lenses typically range from 14 mm to 210 mm and beyond. Of course, the invention is not limited to calibrating cameras of these specifications. As will be appreciated from the description herein, the size of the cage and the distance from the cage at which the camera can be placed are the only factors that limit the cameras 20 that can be calibrated using the invention. Accordingly, differently sized cages and more available space can be used to calibrate virtually any camera 20 of any field of view. Even multiple camera systems may be calibrated together if relative misalignment angles from some common reference frame, namely the sensor frame assembly, are provided.

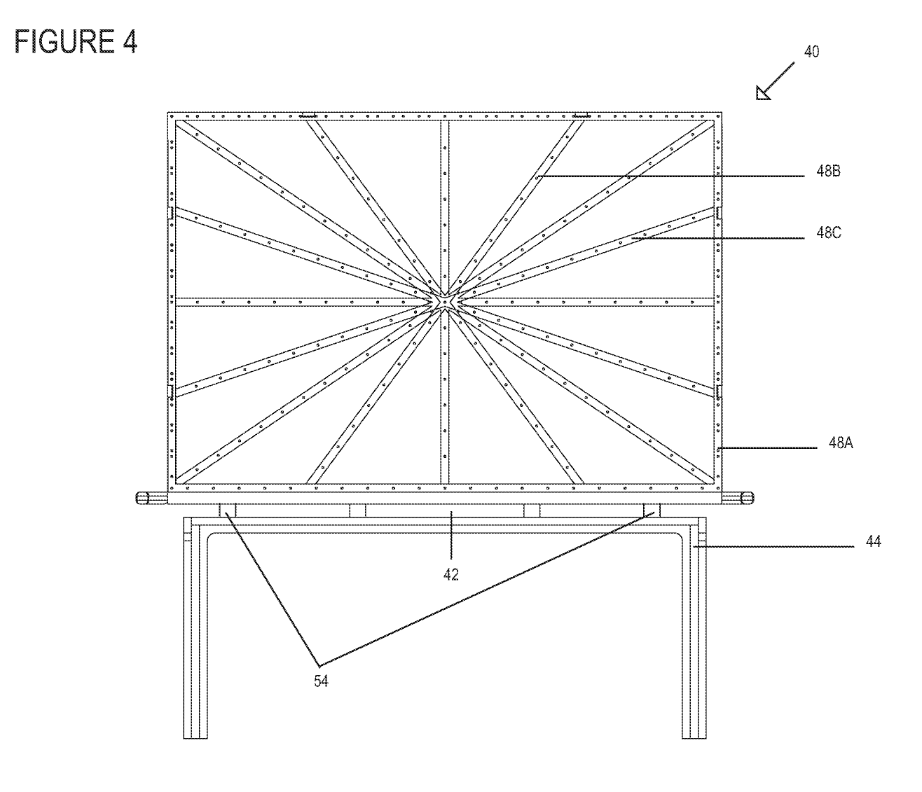

As illustrated in the figures, the calibration cage 40 is disposed on a turntable 42, which in turn rests on a cage stand 44. The calibration cage generally includes an array of targets 46 (also referred to as markers) arranged thereon. In the embodiment illustrated, the targets 46 are disposed on front sides of three rectangular frames 48a, 48b, 48c that are aligned in parallel vertical planes. Also in FIG. 1, each frame 48a, 48b, 48c includes cross arms 50 that extend between sides of the respective frame, in the same plane as the frame. As best illustrated in FIG. 4, the cross arms 50 preferably are staggered in position to ensure visibility of each cross arm on each parallel plane.

Because it is mounted on the rotatable turntable 42, the cage is rotatable in a horizontal plane. While the cage may be rotatable through 360-degrees, in most applications the cage need only be rotatable through a 90-degree arc-45-degrees on either side of a normal or centered position. The turntable preferably utilizes ball bearings to provide for smooth and steady motion and is sized to have sufficient robustness to ensure that rigidity of the frame is maintained. To this end, load-bearing members 54 (shown in FIG. 4) may also be provided under the cage 40, adjacent to the turntable. The load-bearing members 54 will ensure that the cage does not sag at its perimeter under its own weight, especially when the turntable is located centrally with respect to the cage and is significantly smaller than a footprint of the cage.

The turntable 42 also may include an indexing mechanism, such as mechanical stops or the like, to ensure repeated alignment of the cage 40 in predetermined positions. For example, the turntable may be indexable between a normal or centered positioned in which the frames 48a, 48b, 48c are normal to an optical index of the camera to be calibrated and one or more oblique positions, for example, rotated 45-degrees in either direction relative to the normal position.

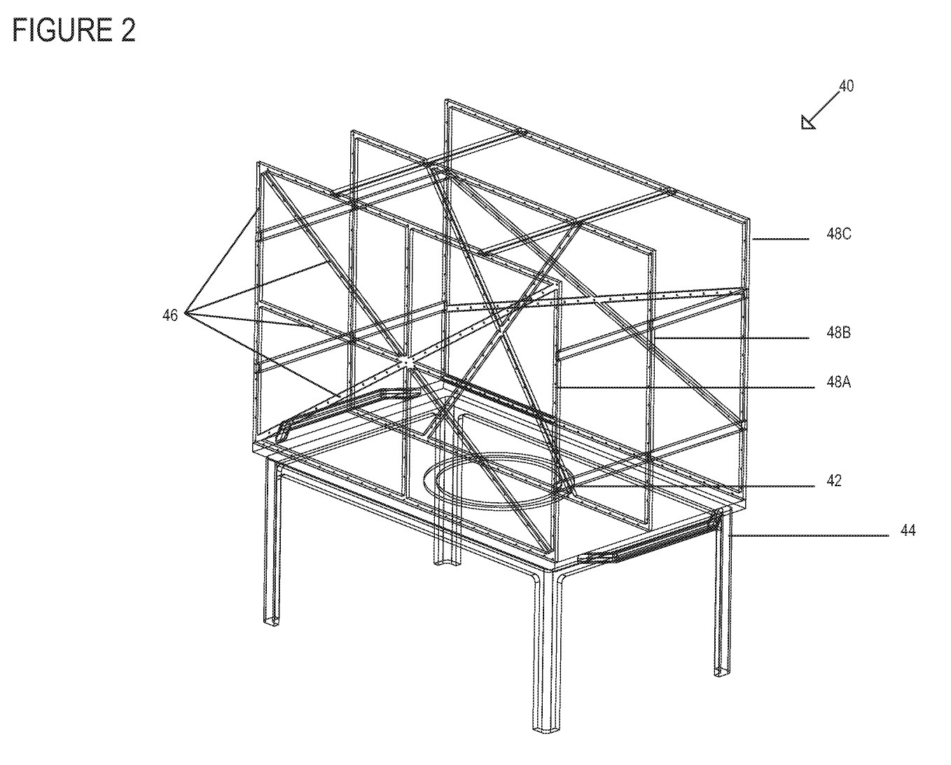

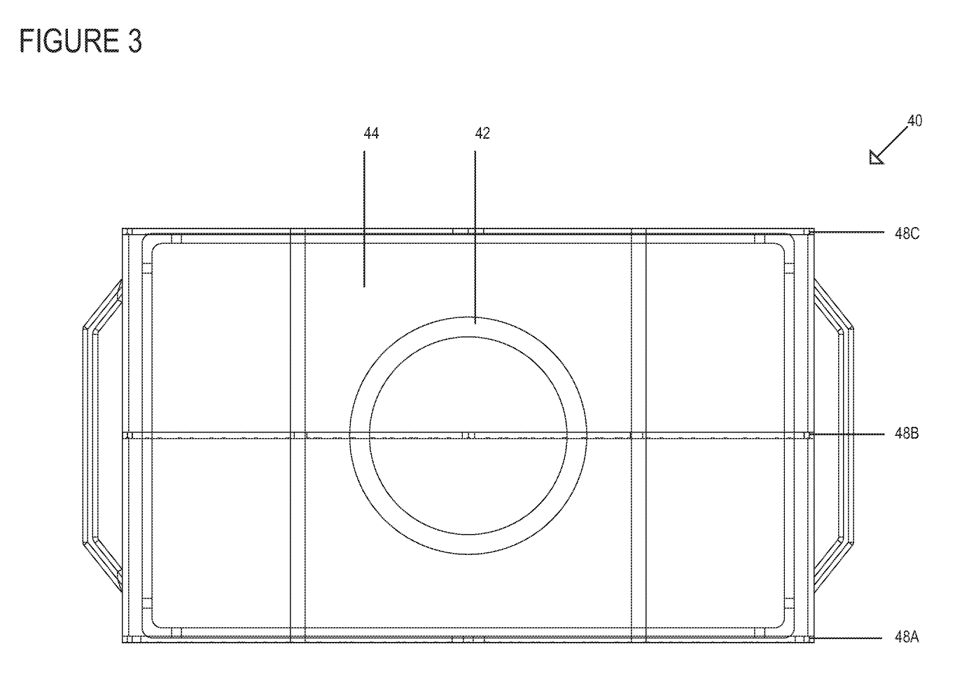

In the preferred embodiment, the cage 40 is sized to fill the field of view of a 3:2 aspect ratio camera. The cage is shown as a rectangular parallelepiped, although this shape is not necessary. The cage may be any shape or configuration that provides for a three-dimensional array of targets. The reference targets are sized and spaced far enough from each other to be distinct regardless of view angle of the cage (up to 45 degrees off center) and the hyperfocal distance of the camera and lens. Of course, the number of targets may vary depending upon the camera to-be-calibrated. Generally, the number of targets required is guided by the lowest resolution camera sensor used. The size and spacing of the targets must be such that the targets can easily be resolved by the sensor. In a cage constructed by the inventors, 361 reference targets 46 were used, disposed on three frames like those illustrated in FIGS. 1-4. The targets 46 were 7 mm diameter targets spaced 80 mm apart. The inventors found that such targets were readily resolved, even by a wide angle lens on a low resolution sensor, and were easily distinguished from one another when imaged by a 180 mm lens on a low resolution sensor placed close to the cage structure. Close placement of the camera relative to the cage may be necessary due to limited space available in the facility. Close placement and lens fixed to infinite focus can cause the blur circles of calibration targets to become overlapping rendering them useless. As noted above, sufficient spacing between targets resolves this issue.

The frame material for the cage preferably has a low coefficient of linear expansion so as to minimize movement of reference points when exposed to periods of intense lighting. The embodiment constructed by the inventors employed wood with a typical value near 3×10⁻⁶ in/in ° F. Any number of materials, including but not limited to metals and plastics could be used to make up the cage. For example, aluminum can be used, although aluminum has a linear expansion coefficient around 12×10⁻⁶ in/in ° F. Thus, the wooden structure allows for a four-times lower amount of movement with any variation in temperature than the metal cage.

The markers or targets used should create a high amount of contrast when compared to the material making up the cage. To this end, in a preferred embodiment, the cage material is painted a flat black and the markers are preferably white or retroreflective. Other combinations of colors and materials can be used, although it is desirable that the combinations provide high contrast and the targets should be visible in a wide spectrum of light. For example, the retroreflective targets noted above can operate from just below 400 nm to above 900 nm, which allows for calibration of cameras in the visible wavelength range and up into the near infrared region.

The cage 40 is also adaptable for use in calibrating thermal or longwave IR cameras. Specifically, this functionality can be supported by making the targets 46 out of heat sources. Any heating device may be used, as long as it is relatively small, compact, preferably numerous and easily installed. In one preferred embodiment, the targets 46 includes resistors wired in series, to which a controlled voltage may be applied to heat up the resistors, creating compact sources of heat. As should be appreciated by one of ordinary skill in the art, other heating devices may alternatively be used. The resistors provide an easily centroided region of contrast for a thermal camera. As typical thermal cameras have far fewer pixels then RGB cameras, fewer targets may be used. The inventors have found that for some cameras, the resistors are sufficient if spaced about 10 inches apart along each section of the cage. Like the visible targets discussed above, these thermal targets should be attached to a side of each frame that maximizes the view from the camera. Any heating device may be used, as long as it is relatively small, compact, preferably numerous and easily installed.

The inventors also have constructed a multiple-use cage that includes both photo and thermal targets. As noted above, because thermal cameras will generally require fewer targets for calibration, thermal targets can be readily interspersed between the photo targets in a target array.

The light source 60 can be any conventional light source; the inventors have used a light source having a halogen bulb. The light source 60 is mounted directly above and slightly behind the camera lens and body. This enables the light to be nearly directly pointed at the targets at all times, needing only small adjustments to illuminate the cage fully. In a preferred embodiment, all targets are adequately illuminated for easy processing.

The capture station 80 includes a computer 82 for storing calibration images captured by the camera 20. The capture station also hosts a commercially available calibration software package (for example, “Australis” from Photometrix or “PhotoModeler” from EOS Systems). The capture station 80 preferably also includes a power supply and computer equipment required for collecting, previewing, and storing imagery.

According to a process for capturing images for the calibration process, instead of moving the camera between a number of distributed locations (9 arranged in a 3×3 grid in some prior art applications) to collect images of the cage, the present invention rotates the cage 40 via the turntable 42 in a stable and smooth way as discussed above. This allows the operator to minimize setup and positioning time.

In a method according to the invention, the operator takes a series of pictures of the cage with the cage in a center or normal position, in which the frames 48a, 48b, 48c are normal to the optical axis of the camera 20. The series of pictures preferably includes taking pictures of the cage at various heights. To this end, the camera may be placed on a stand, such as a tripod, that the user can manipulate vertically, or the turntable may be placed on a vertical translator that allows for up and down movement of the cage. This translator may be a jack or actuator, such as a hydraulic or pneumatic jack or actuator. Alternatively, the cage or stand may be indexable between different heights relative to the ground.

Once the series of images is captured with the cage at the normal position, the cage is rotated to each side. In the preferred embodiment, the cage is rotated about 45-degrees in each direction, although other degrees of rotation can be used. A series of images are then captured at each of these oblique or rotated positions of the cage 40. These series of images preferably include images taken at the same heights as those taken with the cage in the normal position. The camera also preferably is moved further from the cage when the cage is in the rotated positions.

In one experiment conducted by the inventors, seven images were captured at three heights of the camera at the normal position, seven were captured with the cage rotated approximately 45-degrees to the right, and eight more were captured with the cage rotated approximately 45-degrees to the left. The images captured at the rotated positions were taken with the camera moved back to a distance of 1.4×, where x is the distance from the camera to the cage along the optical axis during capturing of images with the cage in the normal position. In the experiment, twenty-two images were taken in total. These included a variety of rolls at each position and two ‘oblique’ shots taken at a 45 degree roll from normal orientation to either side for additional convergent geometry.

Accuracy of the final results using the cage of this invention has been confirmed using three measurements, namely, (1) the RMS of image coordinates, which compares the estimated solution of the captured cage images corrected by the final lens model against the initial gage model and results in an average RMS measure of every target coordinate; (2) the final standard error, which measures the confidence of bundle adjusted solution for each lens model parameter; and (3) a comparison of limiting STD error estimates to Total STD error estimates, which was found to be less that 10 um in each axis.

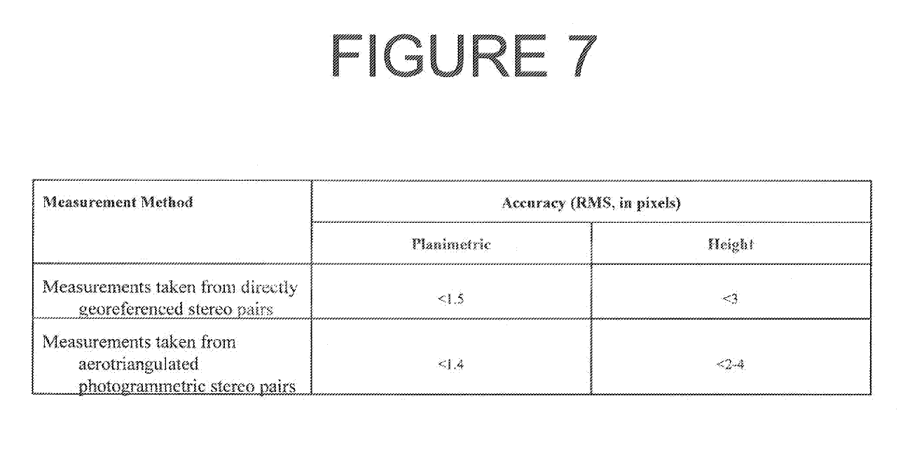

In addition to these self checks, the lens distortion parameters have yielded consistently good results in the field. This has been tested by flying aerial boresight calibration flights over highly accurate ground control point fields shown with the results as shown in FIG. 7. As for the ultimate geocalibration accuracy achieved, it is believed to be on the upper edge of the theoretical limits of the ground based close-range bundle adjustment based camera calibration. Focal length may vary from geocalibration to geocalibration by less than +/−10 um. Xp and Yp are repeatable to within +/−1 pixel also. Distortion terms normally come within one-half to one-eighth of a pixel repeatability.

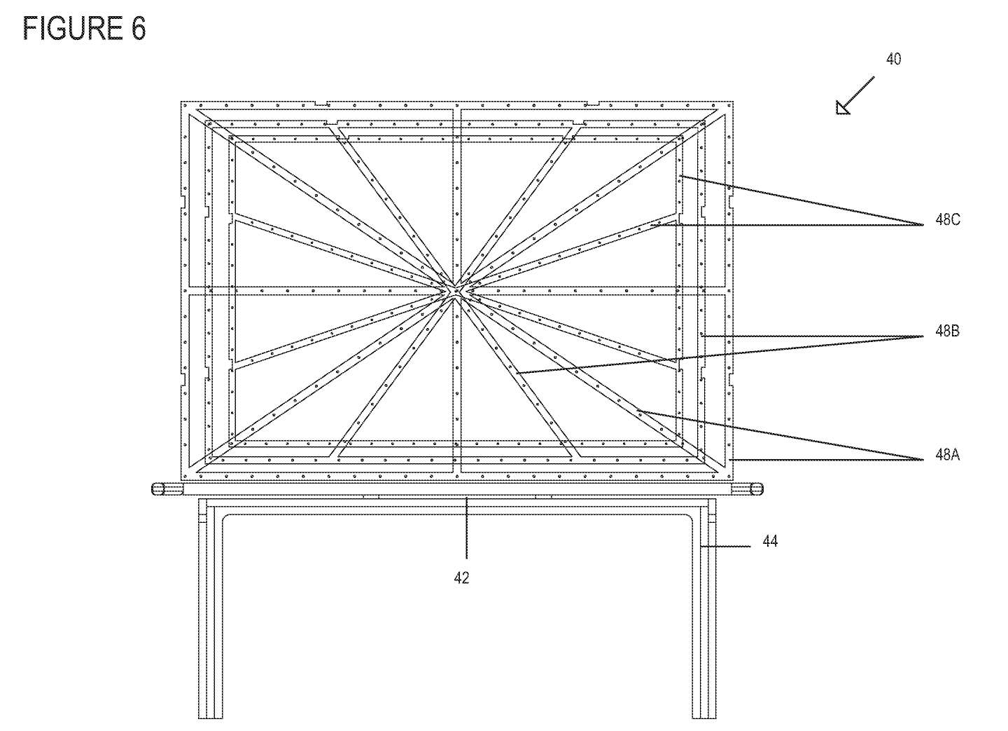

Modifications of the foregoing embodiments also are contemplated. For example, while providing the cage on a turntable allows for easier setup and better repeatability of camera positions in a horizontal plane, as noted above, vertical movement of the camera and rotation about a horizontal axis may still be required to capture all images required for calibration. Accordingly, the invention could include a translational actuator that moves the cage in the vertical direction. Such an embodiment is illustrated in FIG. 6. more specifically, the turntable 42 of FIG. 6 is mounted on a lift 52 that moves the turntable (and thus the cage) vertically. The lift may be any known actuator and may be manually or automatically (e.g., electrically, pneumatically, hydraulically) actuated. Similarly, the turntable and cage may be mounted on a base that is rotatable about a horizontal axis. The cage and/or camera also could be placed on a trolley or the like to promote movement of the camera and/or cage relatively closer and farther from each other.

In the embodiments described above, the frames 48a, 48b, 48c are sized the same. More specifically, they have substantially the same outer perimeter. However, this is not required. In the embodiment illustrated in FIG. 6, for example, the frames have differently-sized outer perimeters. Specifically, the frame 48a, which is closest to the camera, has a slightly larger outer perimeter than the frame 48b, which in turn has a slightly larger outer perimeter than the frame 48c. In this manner, the members making up the outer perimeter are all visible, that is, neither is hid behind the closer frame when viewing the cage from a position normal to the planes in which the frames are situated.

While the invention has been described in connection with certain presently preferred embodiments thereof, those skilled in the art will recognize that many modifications and changes may be made therein, without departing from the true spirit and scope of the invention, which accordingly is intended to be defined solely be the appended claims.

1. A calibration cage for calibrating a camera comprising:
a base;
a rotatable turntable disposed on the base and rotatable relative to the base;
a cage disposed on the turntable and thereby for rotation relative to the base between a normal position and at least one predetermined rotated position; and
an array of targets disposed at predetermined locations on the cage.

2. The calibration cage of claim 1, wherein the array of targets is a three-dimensional array.

3. The calibration cage of claim 1, wherein the cage comprises a plurality of frames arranged in parallel and wherein the array of targets includes targets arranged on each of the plurality of frames.

4. The calibration cage of claim 3, wherein the plurality of frames have substantially the same perimeter.

5. The calibration cage of claim 3, wherein the plurality of frames have different perimeters.

6. The calibration cage of claim 5, wherein the plurality of frames have successively smaller perimeters at distances farther from a front of the calibration cage.

7. The calibration cage of claim 1, wherein the frames are rectangular.

8. The calibration cage of claim 3, further comprising one or more cross-arms extending between two position on an outer perimeter of one of the plurality of frames.

9. The calibration cage of claim 8, wherein each frame includes at least one cross arm, the cross arms being oriented differently in each frame.

10. The calibration cage of claim 1, further comprising a translator for translating the cage in a direction perpendicular to a plane of rotation of the turntable.

11. A system for calibrating a camera comprising:
a camera having a field of view;
a rotatable turntable;
a calibration cage mounted on the turntable and spaced from the camera, the calibration cage having a three-dimensional array of targets disposed in the field of view of the camera, wherein the turntable is actuatable to rotate the calibration cage between a plurality of view angles, each of the plurality of view angles presenting the three-dimensional array of targets differently in the field of view of the camera.

12. The system of claim 11, wherein the camera includes a focal axis and the camera is arranged such that the focal axis is coincident with a center plane of the cage when the cage is in a normal view angle.

13. The system of claim 11, wherein the targets are photoreflective and further comprising a light source arranged proximate the camera to illuminate the photoreflective targets.

14. The system of claim 11, wherein the calibration cage comprises a plurality of frames arranged in parallel, the targets being disposed on each of the frames.

15. The system of claim 14, wherein at least one of the plurality of frames comprises a cross member extending between two segments of the frame.

16. The system of claim 14, wherein the plurality of frames are differently sized such that the frame closest to the camera is larger than frames arranged opposite the frame closest to the camera.

17. A method of calibrating a camera comprising:
providing a camera to be calibrated, the camera having a field of view;
providing a calibration cage spaced from the camera, the calibration cage having a three-dimensional array of targets disposed in the field of view of the camera;
mounting the calibration cage on a turntable;
capturing a first image of the calibration cage using the camera;
rotating the calibration cage on the turntable to a rotated position, still in the field of view of the camera;
capturing a second image of the calibration cage using the camera; and
calibrating the camera based on the first and second captured images.

18. The method of claim 17 further comprising analyzing the first and second images to calibrate the camera.

19. The method of claim 17 further comprising capturing additional images at alternative camera positions obtained by translating the camera one of horizontally and vertically, while maintaining the position of the calibration cage.

20. The method of claim 17 further comprising capturing additional images at alternative calibration cage positions obtained by translating the calibration cage one of horizontally and vertically while maintaining the position of the camera.
